(19) United States
(12) Patent Application Publication
(10) Pub. No.: US 2026/0036067 A1
(43) Pub. Date: Feb. 5, 2026

(54) TURBINE SHROUD ASSEMBLIES WITH AIR ACTIVATED BUFFER CAVITY SEALS

(71) Applicant: Rolls-Royce Corporation, Indianapolis, IN (US)

(72) Inventors: Aaron D. Sippel, Indianapolis, IN (US); Ted J. Freeman, Indianapolis, IN (US); David J. Thomas, Indianapolis, IN (US); Clark J. Snyder, Indianapolis, IN (US)

(21) Appl. No.: 18/680,573

(22) Filed: May 31, 2024

(51) Int. Cl. F01D 25/24; F01D 11/08

(52) U.S. Cl. CPC F01D 25/24; F01D 11/08; F05D 2220/32; F05D 2240/55

(57) ABSTRACT

A turbine shroud assembly adapted for use with a gas turbine engine includes a carrier segment, a blade track segment, and a seal system. The carrier segment arranged circumferentially at least partway around an axis. The blade track segment is coupled to the carrier segment and defines a portion of a gas path of the gas turbine engine. The seal system includes seals arranged radially between the carrier segment and the blade track segment to block gases from flowing between the carrier segment and the blade track segment.

### FIELD OF THE DISCLOSURE

The present disclosure relates generally to turbine shroud assemblies, and more specifically to sealing of turbine shroud assemblies used with gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, tips of the blades move along blade tracks included in static shrouds that are arranged around the rotating wheel assemblies. Such static shrouds may be coupled to an engine case that surrounds the compressor, the combustor, and the turbine.

Some shrouds positioned in the turbine may be exposed to high temperatures from products of the combustion reaction in the combustor. Such shrouds sometimes include components made from materials that have different coefficients of thermal expansion. Due to the differing coefficients of thermal expansion, the components of some turbine shrouds expand at different rates when exposed to combustion products. In some examples, sealing between and coupling such components may present challenges.

### SUMMARY

The present disclosure may comprise one or more of the following features and combinations thereof.

A turbine shroud assembly adapted for use with a gas turbine engine may include a carrier segment, a blade track segment, and a seal system. The carrier segment may be arranged circumferentially at least partway around an axis. The blade track segment may be arranged circumferentially at least partway around the axis to define a portion of a gas path of the gas turbine engine. The seal system may be arranged radially between the carrier segment and the blade track segment to block gases from flowing between the carrier segment and the blade track segment.

In some embodiments, the carrier segment may include an outer wall, a forward support wall, and an aft support wall. The forward support wall may extend radially inward from the outer wall. The aft support wall may extend radially inward from the outer wall at a location spaced apart axially from the forward support wall to define an attachment-receiving space.

In some embodiments, the blade track segment may include a shroud wall and an attachment feature. The shroud wall may extend circumferentially partway around the axis. The attachment feature may extend radially outward from the shroud wall into the attachment-receiving space formed in the carrier segment.

In some embodiments, the seal system may include a buffer air seal assembly radially between the forward support wall of the carrier segment and the shroud wall of the blade track segment to block gases from flowing between the carrier segment and the blade track segment. The buffer air seal assembly may include a first seal member and a second seal member. The first seal member and the second seal member may each extend radially into the carrier segment and the blade track segment. The second seal member may be spaced apart axially from the first seal member to define a buffer chamber axially therebetween.

In some embodiments, the carrier segment may be formed to include at least one buffer air passageway. The at least one buffer air passageway may be configured to discharge buffer air radially inward away from carrier segment into the buffer chamber axially between the first seal member and the second seal member to pressurize the buffer chamber to urge the first seal member axially forward and the second seal member axially aft away from each other and into engagement with radially-extending surfaces defined by the carrier segment and the blade track segment.

In some embodiments, the forward support wall may be formed to include a radially-inwardly opening first channel and a radially-inwardly opening second channel. The second channel may be spaced apart axially from the first channel to define a partition wall therebetween. The first and second channels may each extend circumferentially relative to the axis. The first seal member may extend into the first channel and the second seal member may extend into the second channel.

In some embodiments, the at least one buffer air passageway extends through the partition wall. The at least one buffer air passageway extends through the partition wall axially between the first channel and the second channel formed in the forward support wall of the carrier segment.

In some embodiments, the first channel may define a radially-extending first support-wall surface engaged by the first seal member. In some embodiments, the second channel may define a radially-extending second support-wall surface engaged by the second seal member.

In some embodiments, the first channel and the second channel may each have a rectangular cross-sectional shape viewed circumferentially relative to the axis. In some embodiments, the first channel may have a rectangular cross-sectional shape viewed circumferentially relative to the axis. In some embodiments, the second channel may have a rectangular cross-sectional shape viewed circumferentially relative to the axis.

In some embodiments, the first channel may define a first end surface, a first support-wall surface, and a second support-wall surface. The first support-wall surface may extend radially inward from the first end surface. The first partition-wall surface may extend radially inward from the first end surface at a location spaced apart axially from the first support-wall surface.

In some embodiments, the second channel may define a second end surface, a second support-wall surface, and a second partition-wall surface. The second support-wall surface may extend radially inward from the second end surface. The second partition-wall surface may extend radially inward from the second end surface at a location spaced apart axially from the second support-wall surface.

In some embodiments, the first seal member may engage the first support-wall surface. In some embodiments, the second seal member may engage the second support-wall surface.

In some embodiments, the shroud wall may be formed to include a radially-outwardly opening third channel. The third channel may extend circumferentially partway about the axis and axially between the first channel and the second channel. The first seal member and the second seal member may each extend into the third channel.

In some embodiments, the third channel may define a radially-extending first shroud-wall surface and a radially-extending second shroud-wall surface. The radially-extending first shroud-wall surface may be engaged by the first seal member. The radially-extending second shroud-wall surface may be engaged by the second seal member.

In some embodiments, the third channel may have a rectangular cross-sectional shape viewed circumferentially relative to the axis. In some embodiments, the third channel defines a third end surface, a first shroud-wall surface, and a second shroud-wall surface. The first shroud-wall surface may extend radially outward from the third end surface. The second shroud-wall surface may extend radially outward from the third end surface at a location spaced apart axially from the first shroud-wall surface. The first seal member may engage the first shroud-wall surface and the second seal member may engage the second shroud-wall surface.

In some embodiments, the shroud wall of the blade track segment may include a coating layer. The blade track segment may include the coating layer on the shroud wall in the third channel. The first seal member and the second seal member may each engage the coating layer.

In some embodiments, the first seal member and the second seal member may each have a rectangular cross-sectional shape viewed circumferentially relative to the axis. In some embodiments, the first seal member may have a rectangular cross-sectional shape viewed circumferentially relative to the axis. In some embodiments, the second seal member may have a rectangular cross-sectional shape viewed circumferentially relative to the axis. In some embodiments, the first seal member and the second seal member may comprise a solid metallic material.

According to another aspect of the present disclosure, a method may include providing a carrier segment, providing a blade track segment, and providing a buffer air seal assembly. The carrier segment may be arranged circumferentially at least partway around an axis. The blade track segment may be arranged circumferentially at least partway around the axis.

In some embodiments, the carrier segment may be formed to include a radially-inwardly opening first channel, a radially-inwardly opening second channel, and at least one buffer air passageway. The second channel may be spaced apart axially from the first channel. The at least one buffer air passageway may extend radially into the carrier segment.

In some embodiments, the blade track segment may have a shroud wall and an attachment feature. The shroud wall may extend circumferentially partway around the axis. The attachment feature may extend radially outward from the shroud wall. The shroud wall may be formed to include a radially-outwardly opening third channel.

In some embodiments, the buffer air seal assembly may include a first seal member and a second seal member. The first seal member and the second seal member may each extend circumferentially relative to the axis.

In some embodiments, the method may further include arranging the first seal member of the buffer air seal assembly in the first channel formed in the carrier segment. In some embodiments, the method may further include arranging the second seal member of the buffer air seal assembly in the second channel formed in the carrier segment.

In some embodiments, the method may further include arranging the blade track segment adjacent to the carrier segment. The blade track segment may be arranged adjacent to the carrier segment so that the first and second seal members extend into the third channel formed in the blade track segment.

In some embodiments, the method may further include discharging a flow of buffer air through the at least one buffer air passageway radially inward away from the carrier segment axially between the first and second seal members. The flow of buffer air may be discharged through the at least one buffer air passageway radially inward away from the carrier segment axially between the first and second seal members to urge the first seal member axially forward and to urge the second seal member axially aft into engagement with radially-extending surfaces defined by the carrier segment and the blade track segment.

In some embodiments, the method may further include applying a coating layer to the shroud wall. The method may further include applying the coating layer to the shroud wall in the third channel of the shroud wall.

In some embodiments, the first seal member and the second seal member may each have a rectangular cross-sectional shape viewed circumferentially relative to the axis. In some embodiments, the first channel, the second channel, and the third channel may each have a rectangular cross-sectional shape viewed circumferentially relative to the axis.

In some embodiments, the method may further include providing at least one retainer and inserting the at least one retainer axially into the carrier segment and through the attachment feature of the blade track segment. The method may include inserting the at least one retainer axially into the carrier segment and through the attachment feature of the blade track segment to couple the blade track segment to the carrier segment.

These and other features of the present disclosure will become more apparent from the following description of the illustrative embodiments.

### BRIEF DESCRIPTION OF THE DRAWINGS

FIG. 1 is a cut-away perspective view of a gas turbine engine showing that the exemplary engine includes a fan, a compressor, a combustor, and a turbine and suggesting that the turbine includes turbine wheel assemblies and static vane assemblies surrounded by a turbine shroud assembly;

FIG. 2 is a partial cross-sectional view of the gas turbine engine of FIG. 1 showing a portion of the turbine in which the turbine shroud assembly is located radially outward from blades of a turbine wheel assembly to block gasses from passing over the blades without interacting with the blades, and further showing the turbine shroud assembly includes a carrier segment, a blade track segment coupled to the carrier segment to define a portion of a gas path of the gas turbine engine, and a seal system configured to seal between the carrier segment and the blade track segment to block gases flowing through the gas path from flowing between the carrier segment and the blade track segment;

FIG. 3 is a perspective view of a portion of the turbine shroud assembly of FIG. 2 showing the turbine shroud assembly includes the carrier segment and the blade track segment made from ceramic matrix composite materials coupled to the carrier segment;

FIG. 4 is an exploded view of the turbine shroud assembly of FIG. 3 showing the seal system includes a forward seal assembly having first and second seal members configured to be arranged in respective channels formed in the carrier segment and an aft seal assembly having a plurality of seal members configured to be arranged in a respective channel formed in the carrier segment;

FIG. 5 is a cross-section view of the turbine shroud assembly of FIG. 3 taken along line 5-5 showing the forward support wall of the carrier segment is formed to include a radially-inwardly opening first channel that receives the first seal member included in the forward seal assembly, a radially-inwardly opening second channel spaced apart axially from the first channel that receives the second seal member included in the forward seal assembly, and a buffer air passageway configured to discharge buffer air into a buffer air cavity formed between the first and second seal members, and further showing the shroud wall of the blade track segment is formed to include a radially-outwardly opening third channel that receives the first seal member and the second seal member;

FIG. 6 is a detail view of FIG. 5 showing the forward seal assembly-also referred to as the buffer air seal assembly-includes the first seal arranged in the first channel and the second seal arranged in the second channel so that buffer air is discharged axially between the two seals to urge the first seal member axially forward and the second seal member axially aft into engagement with the radially-extending surfaces defined by the channels in the carrier segment and the blade track segment;

FIG. 7 is a cross-section view of the turbine shroud assembly of FIG. 3 taken along line 7-7 showing the forward support wall is formed to include a plurality of buffer air passageways spaced apart circumferentially about the axis, and further showing each buffer air passageway extends radially into the forward support wall of the carrier segment from a cavity formed in the outer wall of the carrier segment;

FIG. 8 is a cross-section view of another turbine shroud assembly similar to the turbine shroud assembly of FIG. 5 showing the forward support wall of the carrier a single radially-inwardly opening first channel that receives a seal member and a buffer air passageway configured to discharge buffer radially inward from the carrier segment air axially aft of the seal member, and further showing the shroud wall of the blade track segment is formed to include a radially-outwardly opening second channel that receives the seal member; and

FIG. 9 is a detail view of FIG. 8 showing the forward seal assembly-also referred to as the buffer air seal assembly-includes the first seal arranged in the first channel, and further showing the buffer air passageway discharging buffer air radially inward from the carrier segment air axially aft of the seal member to urge the seal member axially forward into engagement with the radially-extending surfaces defined by the channels in the carrier segment and the blade track segment.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

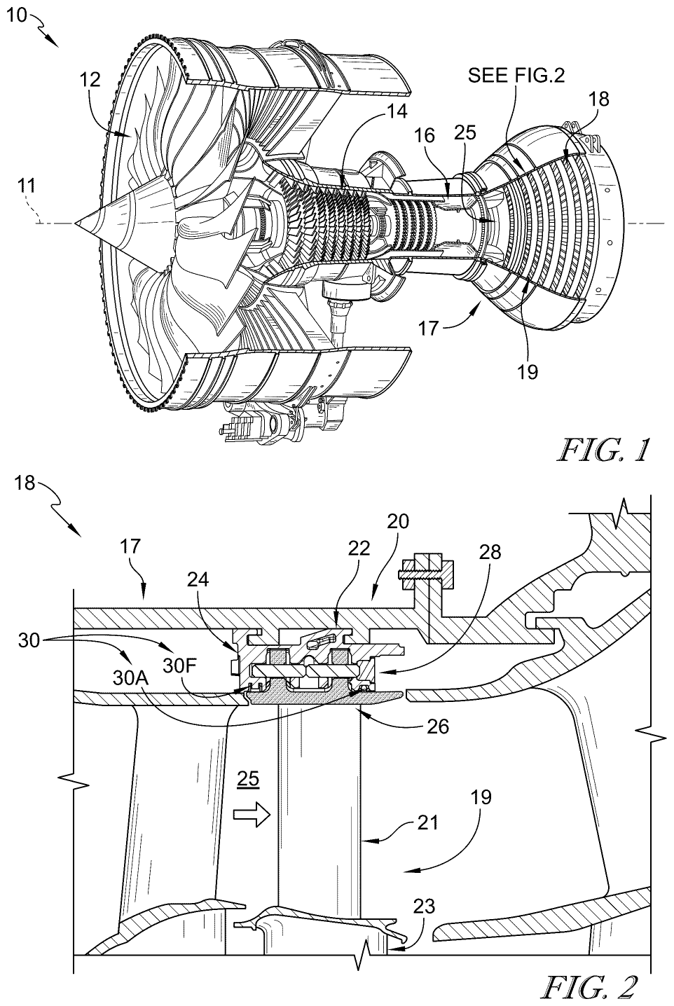

A turbine shroud segment 22 is shown in FIGS. 2-6 and is adapted for use in a gas turbine engine 10 as shown in FIG. 1. The turbine shroud segment 22 includes a carrier segment 24 arranged circumferentially at least partway around an axis 11 of the gas turbine engine 10, a blade track segment 26 arranged circumferentially at least partway around the axis 11, a mount system 28 configured to couple the carrier segment 24 to the blade track segment 26, and a seal system 30 as shown in FIGS. 2-6. The seal system 30 is configured to seal gaps between the carrier segment 24 and the blade track segment 26 to prevent or block gases from a gas path 25 of the gas turbine engine 10 from flowing between the carrier segment 24 and the blade track segment 26.

The blade track segment 26 is a ceramic matrix composite component configured to directly face the high temperatures of the gas path 25 of the gas turbine engine 10 to define a portion of the gas path 25. The carrier segment 24 is a metallic support component configured to interface with other metallic components of the gas turbine engine 10, such as the case 17, to support the blade track segment 26 to radially locate the blade track segment 26 relative to the axis 11. The mount system 28 includes at least one retainer 80, 82, and illustratively the mount system 28 includes two retainers 80, 82 that each extend axially into the blade track segment 26 and the carrier segment 24 to couple the blade track segment 26 to the carrier segment 24. The seal system 30 is arranged radially between the carrier segment 24 and the blade track segment 26 to seal a cavity 48 (sometimes referred to as an attachment-receiving space) defined by the carrier segment 24 to block gases from flowing between the carrier segment 24 and the blade track segment 26 and into the cavity 48.

The seal system 30 includes a forward seal assembly 30F and an aft seal assembly 30A as shown in FIGS. 2 and 4-6. The forward seal assembly 30F is located radially between the carrier segment 24 and the blade track segment 26 on a forward side of the blade track segment 26. The aft seal assembly 30A located radially between the carrier segment 24 and the blade track segment 26 on an aft side of the blade track segment 26. The forward seal assembly 30F includes first and second seal members 32, 34 that each extend radially into the carrier segment 24 and the blade track segment 26. The aft seal assembly 30A includes a plurality of seal members 38A, 38B, 38C arranged in the third channel 56 formed in the carrier segment 24.

The forward seal assembly 30F includes a first seal member 32 and a second seal member 34 as shown in FIGS. 4-7. The first seal member 32 and the second seal member 34 each extend circumferentially about the axis 11. Each seal member 32, 34 extends radially into the carrier segment 24 and the blade track segment 26. The first seal member 32 is spaced apart axially from the second seal member 34 to define a buffer air cavity 58, or also sometimes referred to as a buffer chamber 58, therebetween.

During operation of a gas turbine engine 10, the hot, high-pressure products directed into the turbine 18 from the combustor 16 flow across a radially-inwardly opening surface of a shroud wall 70 of the blade track segment 26 that defines a portion of the gas path 25. The seal system 30 blocks the hot, high-pressure products from flowing into the cavity 48 of the turbine shroud segment 22. Some turbine shroud assemblies use seals having at least two seal members, where one of the seals is configured to be compressed between the carrier segment 24 and the blade track segment 26 to bias the other seal member(s) into engagement with the shroud wall 70 of the blade track segment 26, thereby improving the seal therebetwen.

In some embodiments, the carrier segment 24 may also include buffer air passageways to direct relatively high-pressure air (sometimes referred to as buffer air) into the channel(s) formed in the carrier segment 24 to distribute the high-pressure air along the seal members. The high-pressure air supplied to the channel(s) is used help keep the gases in the gas path 25 out of the cavity 48 in the event of a seal failure. The high-pressure or buffer air is usually jetted through the seal members arranged in the channel(s), which may cause the seal members to wear, specifically oxidize, significantly reducing the overall life of the seal members and the effectiveness of the seal members.

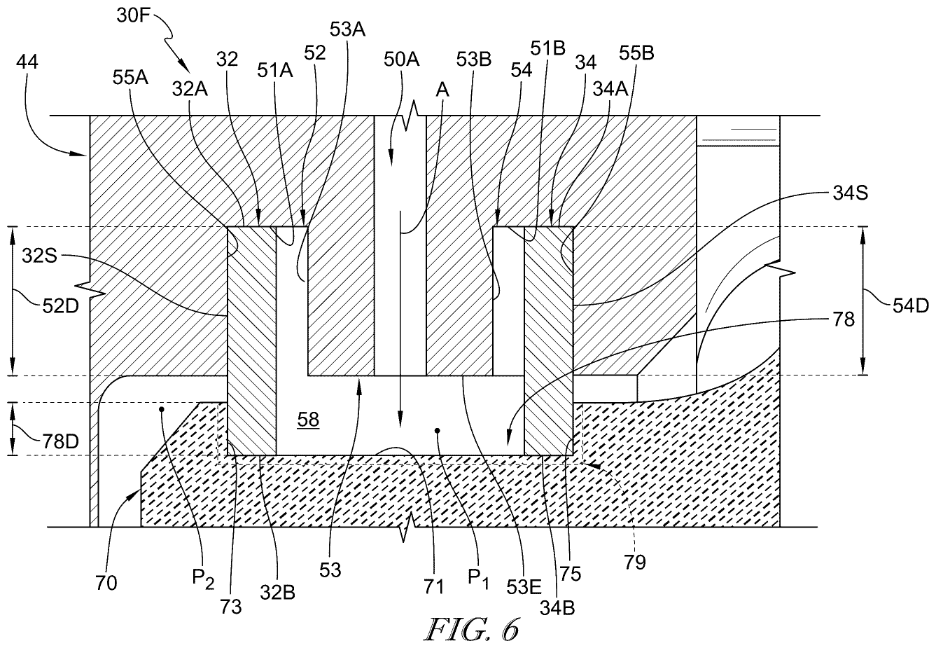

Instead of using another seal member to urge the other seal member(s) into engagement with the shroud wall 70 of the blade track segment 26, the forward seal assembly 30F—also referred to as the buffer air seal assembly 30F—is pressure-activated. The buffer air is discharged into a space or buffer air cavity 58 axially between the seal members 32, 34 as suggested by arrows A in FIG. 6. The buffer air discharged pressurizes the buffer air cavity 58 or buffer chamber 58 axially between the first and second seal members 32, 34 to urge the first seal member 32 axially forward and the second seal member 34 aft into engagement with radially-extending surfaces 55A, 55B, 73, 75 defined by the carrier segment 24 and the blade track segment 26. This eliminates the need for a compressible seal member to bias the seal members 32, 34 into engagement with the carrier segment 24 and the blade track segment 26. The pressure activation of the buffer air seal assembly 30F causes the first seal member 32 to be urged axially forward into engagement with surfaces 55A, 55B, 73, 75 and causes the second seal member 34 to be urged axially aft into engagement with surfaces 55A, 55B, 73, 75

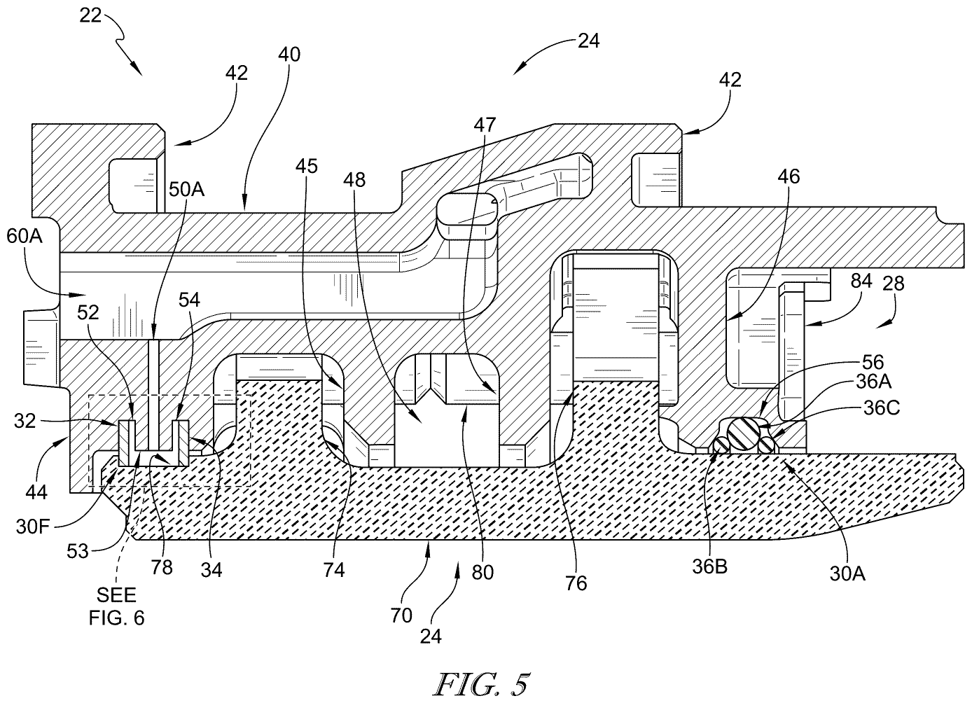

The buffer air seal assembly 30F includes a first seal member 32 that extends into a radially-inwardly opening first channel 52 formed in the carrier segment 24 and a second seal member that extends into a radially-inwardly opening second channel 54 formed in the carrier segment 24 as shown in FIGS. 5 and 6. Both channels 52, 54 extend circumferentially relative to the axis 11. The second channel 54 is spaced apart axially from the first channel 52 to define a partition wall 53 axially therebetween.

Both of the first seal member 32 and the second seal member 34 also extend into a radially-outwardly opening third channel 78 formed in the blade track segment 26. The third channel 78 extends circumferentially relative to the axis 11. The third channel 78 extends axially between the first and second channels 52, 54 in the carrier segment 24.

The channels 52, 54, 78 define the radially-extending surfaces 55A, 55B, 73, 75 that are engaged by the seal members 32, 34 when the buffer air cavity 58 is pressurized with buffer air as shown in FIGS. 5 and 6. The first seal member 32 engages the surfaces 55A, 73 and the second seal member 34 engages the surfaces 55B, 75.

The first channel 52 is defined by a first end surface 51A, a first partition-wall surface 53A, and a first support-wall surface 55A as shown in FIG. 6. The first partition-wall surface 53A extends radially inward from the first end surface 51A to a terminal end 53E of the partition wall 53. The first support-wall surface 55A extends radially inward from the first end surface 51A. The first partition-wall surface 53A is spaced apart axially from the first support-wall surface 55A.

The second channel 54 is defined by a second end surface 51B, a second partition-wall surface 53B, and a second support-wall surface 55B as shown in FIG. 6. The second partition-wall surface 53B extends radially inward from the second end surface 51B to the terminal end 53E of the partition wall 53. The second support-wall surface 55B extends radially inward from the second end surface 51B. The second partition-wall surface 53B is spaced apart axially from the second support-wall surface 55B.

The third channel 78 is defined by a third end surface 71, a first shroud-wall surface 73, and a second shroud-wall surface 75 as shown in FIG. 6. The first shroud-wall surface 73 extends radially outward from the third end surface 71. The second shroud-wall surface 75 extends radially outward from the third end surface 71. The second shroud-wall surface 75 is spaced apart axially from the first shroud-wall surface 73.

Each of the first and second seal members 32, 34 includes end surfaces 32A, 32B, 34A, 34B and a radially-extending surface 32S, 34S as shown in FIGS. 4 and 6. The radially-extending surface 32S, 34S of the corresponding seal member 32, 34 extends radially between the corresponding end surfaces 32A, 32B, 34A, 34B. The surface 32S of the first seal member 32 engages the surface 55A of the carrier segment 24 and the surface 73 of the blade track segment 26, while the surface 34S of the second seal member 34 engages the surface 55B of the carrier segment 24 and the surface 75 of the blade track segment 26.

The first and second seal members 32, 34 are trapped radially between the carrier segment 24 and the blade track segment 26 so that the ends 32A, 32B, 34A, 34B of the seal members 32, 34 engage the end surfaces 51A, 51B, 71 of the channels 52, 54, 78. Engagement of the seal members 32, 34 with the end surfaces 51A, 51B, 71 helps seal between the carrier segment 24 and the blade track segment 26. The buffer air discharged into the buffer air cavity 58 or buffer chamber 58 may leak around the ends 32A, 32B, 34A, 34B of the seal members 32, 34.

In some embodiments, the buffer air seal assembly 30F may include bias members each arranged radially between the outer end 32A, 34A one of the seal members 32, 34 and the carrier segment 24. The bias members may apply a bias force to urge the seal members 32, 34 radially inward into engagement with the third end surface 71 in the third channel 78. One bias member may be arranged in the first channel 52 radially outward of the first seal member 32 and another bias member may be arranged in the second channel 54 radially outward of the second seal member 34.

In some embodiments, the bias members may be springs. In some embodiments, the bias members may be another suitable type to apply the bias force to the seal members 32, 34.

The buffer air passageway 50A, 50B, 50C extends radially through the partition wall 53 formed between the first and second channels 52, 54 in the carrier segment 24. The buffer air passageway 50A, 50B, 50C discharges the buffer air axially between the first channel 52, i.e. the first seal member 32, and the second channel 54, i.e. the second seal member 34 into the buffer air cavity 58 as shown in FIGS. 5 and 6.

The first and second seal members 32, 34 each comprise a single strip of solid metallic material. Each of the seal members 32, 34 also have a rectangular cross-sectional shape when viewed in the circumferential direction relative to the axis 11. In some embodiments, the first and second seal members 32, 34 are another suitable seal type.

Each of the channels 52, 54, 78 also have a rectangular cross-sectional shape when viewed in the circumferential direction relative to the axis 11. The rectangular shape of the channels 52, 54, 78 defines the respective surfaces 51A, 51B, 53A, 53B, 55A, 55B, 71, 73, 75. In the illustrative embodiment, the depth 52D, 54D of the first and second channels 52, 54 is greater than the depth 78D of the third channel 78 as shown in FIGS. 5 and 6. In some embodiments, the depths 52D, 54D, 78D of the channels 52, 54, 78 may all be equal.

With the seal system 30 of the present disclosure initially described above, the gas turbine engine 10 is now described in more detail. The gas turbine engine 10 includes a fan 12, a compressor 14, a combustor 16, and a turbine 18 as shown in FIG. 1. The fan 12 is driven by the turbine 18 and provides thrust for propelling an air vehicle. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about an axis 11 and drive the compressor 14 and the fan 12. In some embodiments, the fan may be replaced with a propeller, drive shaft, or other suitable configuration.

The turbine 18 includes at least one turbine wheel assembly 19 and a turbine shroud 20 positioned to surround the turbine wheel assembly 19 as shown in FIGS. 1 and 2. The turbine wheel assembly 19 includes a plurality of blades 21 coupled to a rotor disk 23 for rotation with the disk 23. The hot, high pressure combustion products from the combustor 16 are directed toward the blades 21 of the turbine wheel assemblies 19 along the gas path 25. The turbine shroud 20 is coupled to the outer case 17 of the gas turbine engine 10 and extends around the turbine wheel assembly 19 to block gases from passing over the turbine blades 21 during use of the turbine 18 in the gas turbine engine 10.

In the illustrative embodiment, the turbine shroud 20 is made up of a number of turbine shroud segment assemblies 22 that each extend circumferentially partway around the axis 11 and cooperate to surround the turbine wheel assembly 19. In other embodiments, the turbine shroud 20 is annular and non-segmented to extend fully around the axis 11 and surround the turbine wheel assembly 19. In yet other embodiments, certain components of the turbine shroud 20 are segmented while other components are annular and non-segmented.

Each turbine shroud segment 22 includes the carrier segment 24, blade track segment, the mount system 28, and the seal system 30 as shown in FIGS. 2-6. The carrier segment 24 and the blade track segment 26 are arranged circumferentially partway about the axis 11. The blade track segment 26 includes the shroud wall 70 that extends circumferentially partway around the axis 11 to define a portion of the gas path 25 and an attachment feature 72 that extends radially from the shroud wall 70 into the cavity 48 of the carrier segment 24. The mount system 28 is configured to couple the blade track segment 26 to the carrier segment 24. The seal system 30 is arranged radially between the carrier segment 24 and the blade track segment 26 to seal gaps therebetween.

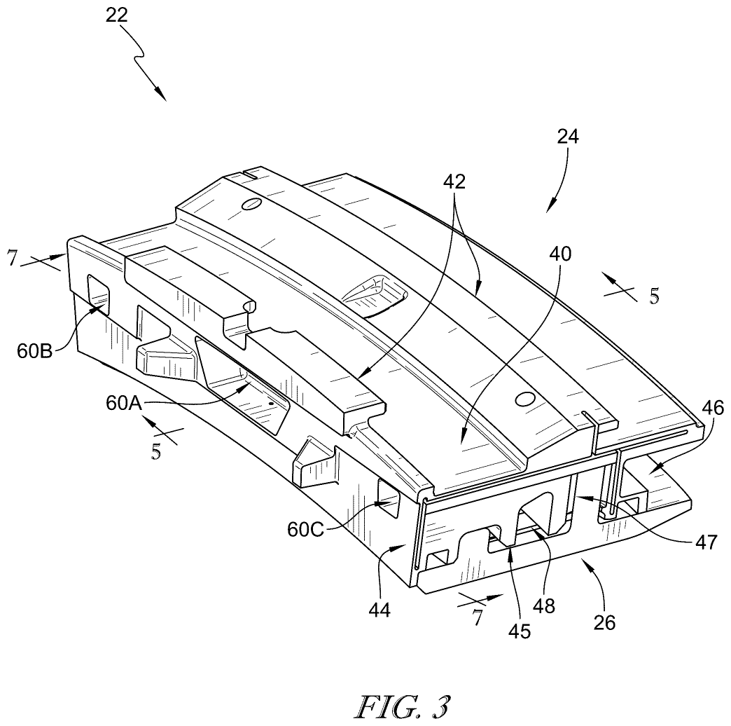

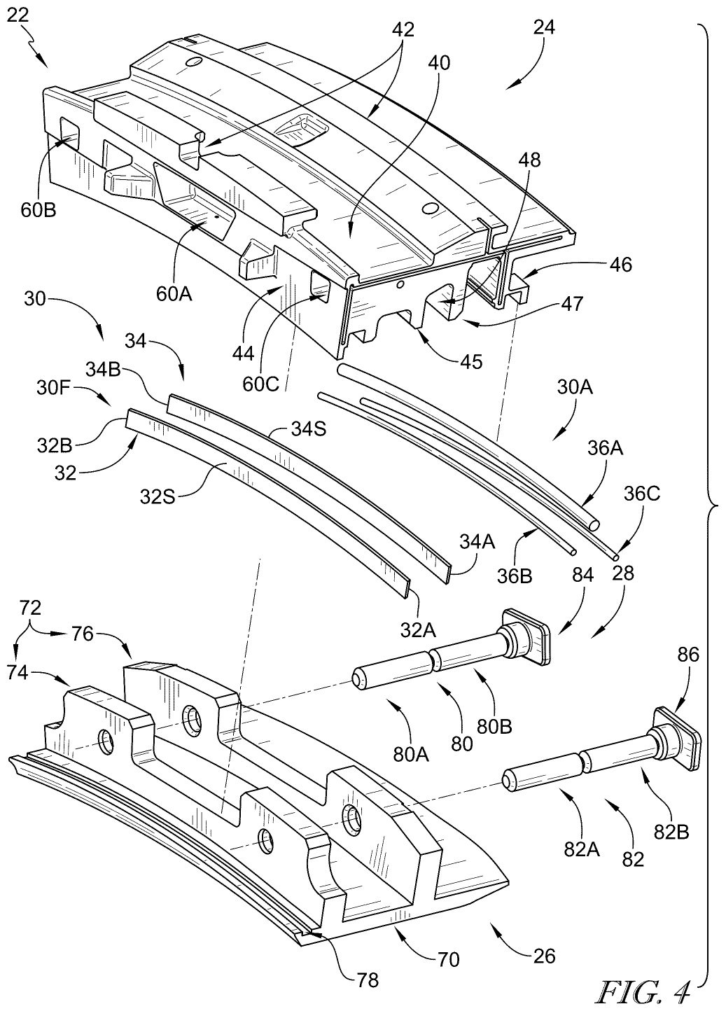

The carrier segment 24 includes an outer wall 40, a pair of hangers 42, a forward support wall 44, and an aft support wall 46 as shown in FIGS. 3-6. The outer wall 40 extends circumferentially at least partway about the axis 11. The hangers 42 extend radially outward from the outer wall 40 and engage the case 17 to couple the turbine shroud segment 22 to the rest of the engine 10. The forward support wall 44 extends radially inward from the outer wall 40 at a forward end of the outer wall 40 axially forward of the attachment feature 72 and the aft support wall 46 extends radially inward from the outer wall 40 at an aft end of the outer wall 40 axially aft of the attachment feature 72.

In the illustrative embodiment, the carrier segment 24 further includes a first intermediate support wall 45 and a second intermediate support wall 47 as shown in FIGS. 3, 4, and 6. The first intermediate support wall 45 and the second intermediate support wall 47 each extend radially inward from the outer wall 40 of the carrier segment 24 axially between the first and second support walls 44, 46. The second intermediate support wall 47 is spaced apart axially from the first intermediate support wall 45 in the illustrative embodiment.

The forward and aft support walls 44, 46 of the carrier segment 24 each include corresponding channels 52, 54, 56 as shown in FIGS. 5 and 6. The forward support wall 44 is formed to include the first channel 52 and the second channel 54. The second channel 54 is spaced apart axially from the first channel 52 to define the partition wall 53 therebetween. The aft support wall 46 is formed to include another channel 56 in the illustrative embodiment.

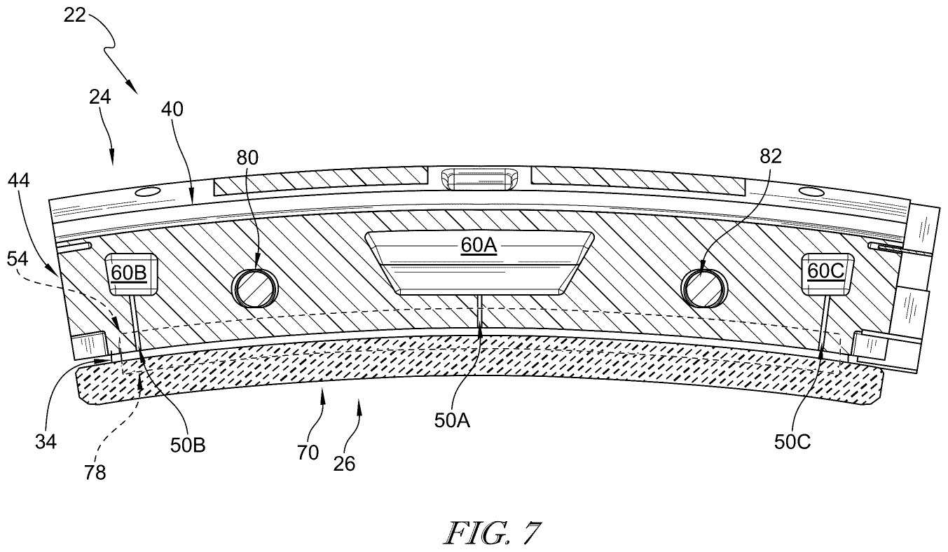

In the illustrative embodiment, only the forward support wall 44 includes the buffer air passageways 50A, 50B, 50C as shown in FIGS. 5-7. The forward support wall 44 includes at least one discrete buffer air passageway 50A, 50B, 50C that extends radially into the forward support wall 44 through the partition wall 53 defined axially between the first channel 52 and the second channel 54. In the illustrative embodiment, the forward support wall 44 includes a plurality of buffer air passageways 50A, 50B, 50C that are spaced apart circumferentially about the axis 11 as shown in FIG. 7.

In the illustrative embodiment, each buffer air passageway 50A, 50B, 50C extends from an outer cavity 60A, 60B, 60C formed in the outer wall 40 of the carrier segment 24 as shown in FIGS. 5 and 7. The buffer air flows from the outer cavity 60A, 60B, 60C to the buffer air passageways 50A, 50B, 50C. In some embodiments, the carrier segment 24 is formed to include an outer cavity 60A, 60B, 60C for each buffer air passageway 50A, 50B, 50C that supplies the corresponding buffer air passageway 50A, 50B, 50C with buffer air.

The first channel 52 formed in the forward support wall 44 is defined by the first end surface 51A, the first partition-wall surface 53A, and the first support-wall surface 55A as shown in FIG. 6. The first partition-wall surface 53A extends radially inward from the first end surface 51A to a terminal end 53E of the partition wall 53. The first support-wall surface 55A extends radially inward from the first end surface 51A. The first partition-wall surface 53A is spaced apart axially from the first support-wall surface 55A.

The second channel 54 formed in the forward support wall 44 is defined by the second end surface 51B, the second partition-wall surface 53B, and the second support-wall surface 55B as shown in FIG. 6. The second partition-wall surface 53B extends radially inward from the second end surface 51B to the terminal end 53E of the partition wall 53. The second support-wall surface 55B extends radially inward from the second end surface 51B. The second partition-wall surface 53B is spaced apart axially from the second support-wall surface 55B.

The blade track segment 26 includes the shroud wall 70 and the attachment feature 72 as shown in FIGS. 4-6. The shroud wall 70 that extends circumferentially partway around the axis 11. The attachment feature 72 includes a first attachment flange 74 and a second attachment flange 76 that each extend radially outward from the shroud wall 70. The second attachment flange 76 is spaced apart axially from the first attachment flange 74.

In the illustrative embodiment, the forward support wall 44 extends radially inward from the outer wall 40 axially forward of the first attachment flange 74 of the blade track segment 26. The aft support wall 46 extends radially inward from the outer wall 40 axially aft of the second attachment flange 76 of the blade track segment 26. The first intermediate support wall 46 extends radially inward from the outer wall 40 axially aft of the first attachment flange 74 so that the first attachment flange 74 is axially between the forward support wall 44 and the first intermediate support wall 45. The second intermediate support wall 47 extends radially inward from the outer wall 40 axially forward of the second attachment flange 76 of the blade track segment 26 so that the second attachment flange 76 is located axially between the aft support wall 46 and the second intermediate support wall 47.

The third channel 78 is defined by a third end surface 71, a first shroud-wall surface 73, and a second shroud-wall surface 75 as shown in FIG. 6. The first shroud-wall surface 73 extends radially outward from the third end surface 71. The second shroud-wall surface 75 extends radially outward from the third end surface 51. The second shroud-wall surface 75 is spaced apart axially from the first shroud-wall surface 73.

In the illustrative embodiment, the shroud wall 70 of the blade track segment 26 has a coating layer 79 as suggested in FIG. 6. The coating layer 79 is in the third channel 78 to define the third end surface 71, the first shroud-wall surface 73, and the second shroud-wall surface 75. The first and second seal members 32, 34 engage the coating layer 79 in the third channel 78.

The mount system 28 includes at least one retainer 80, 82, illustratively two retainers 80, 82 that each extend axially into the blade track segment 26 and the carrier segment 24 to couple the blade track segment 26 to the carrier segment 24. The retainers 80, 82 extend axially into the forward support wall 44, through the first attachment flange 74, the intermediate support walls 43, 45, and the second attachment flange 76, and into the aft support wall 46 of the carrier segment 24 so as to couple the blade track segment 26 to the carrier segment 24.

In the illustrative embodiment, the mount system 28 includes the retainers 80, 82 and corresponding retainer plugs 84, 86 as shown in FIG. 4. Each of the retainer plugs 84 extends into an installation apertures formed in the aft support wall 46 to block removal of the corresponding retainers 80, 82 through the installation apertures in the carrier segment 24.

In the illustrative embodiment, the retainers 80, 82 are both split pins as shown in FIG. 3. Each retainer 80, 82 includes a first pin 80A, 82A and a second pin 80B, 82B arranged axially aft of the first pin 80A, 82A as shown in FIG. 4.

A method of assembling and using the turbine shroud segment 22 may include several steps. The method includes arranging the seal members 32, 34, 36A, 36B, 36C of the seal assemblies 30F, 30A in the corresponding channels 52, 54, 78 before arranging the blade track segment 26 adjacent to the carrier segment 24. The method includes arranging the first seal member 32 in the first channel 52, arranging the second seal member 34 in the second channel 54, and arranging the other seal members 36A, 36B, 36C in the third channel 78. The seal members 32, 34, 36A, 36B, 36C may be arranged in the corresponding channels 52, 54, 78, in any order.

Once all the seal members 32, 34, 36A, 36B, 36C are arranged in the corresponding channels 52, 54, 78, the blade track segment 26 is arranged adjacent to the carrier segment 24 so that the seal members 32, 34, 36A, 36B, 36C of the forward and aft seal assemblies 30F, 30A are radially between the carrier segment 24 and the shroud wall 70 of the blade track segment 26 to block gases in the gas path from flowing between the carrier segment 24 and the blade track segment 26. The blade track segment 26 is arranged adjacent to the carrier segment 24 so that the first and second seal members 32, 34 also extend into the third channel 78 formed in the shroud wall 70 of the blade track segment 26 and the attachment feature 72 extends into the cavity 48. The blade track segment 26 is arranged adjacent to the carrier segment 24 so that the first attachment flange 74 and the second attachment flange 76 extend into sections of the cavity 48.

In some embodiments, the method further includes inserting the retainers 80, 82 into the carrier segment 24 and the blade track segment 26 to couple the blade track segment 26 to the carrier segment 24. The method includes inserting one retainer 80 axially into the carrier segment 24 and through the attachment feature 72 of the blade track segment 26 to couple the blade track segment 26 to the carrier segment 24. The method further includes inserting another retainer 82 axially into the carrier segment 24 and through the attachment feature 72 of the blade track segment 26 to couple the blade track segment 26 to the carrier segment 24. The second retainer 82 is inserted at a location spaced apart circumferentially from the first retainer 80.

The method further includes discharging a flow of buffer air through the at least one buffer air passageway 50A, 50B, 50C. The flow of buffer air is suggested by arrows A. The method may further include discharging the flow of buffer air through the plurality of buffer air passageways 50. The method includes discharging the flow of buffer air through the buffer air passageway 50 radially inward away from the carrier segment axially between the first and second seal members 32, 34 to urge the first seal member 32 axially forward and the second seal member 34 axially aft into engagement with the carrier segment 24 and the blade track segment 26.

The buffer air discharged into the buffer air cavity 58 defined between the two seal members 32, 34 establishes a higher pressure P1 in the buffer air cavity 58 than the pressure P2 in the region axially forward of the buffer air seal assembly 30F and the pressure P3 in the cavity 48 as shown in FIG. 6. The pressure P3 in the cavity 48 is lower than the pressure P2 in the region axially forward of the buffer air seal assembly 30F radially outward of the gas path 25 as shown in FIG. 6. The buffer air may be provided from the compressor 14 of the gas turbine engine 10.

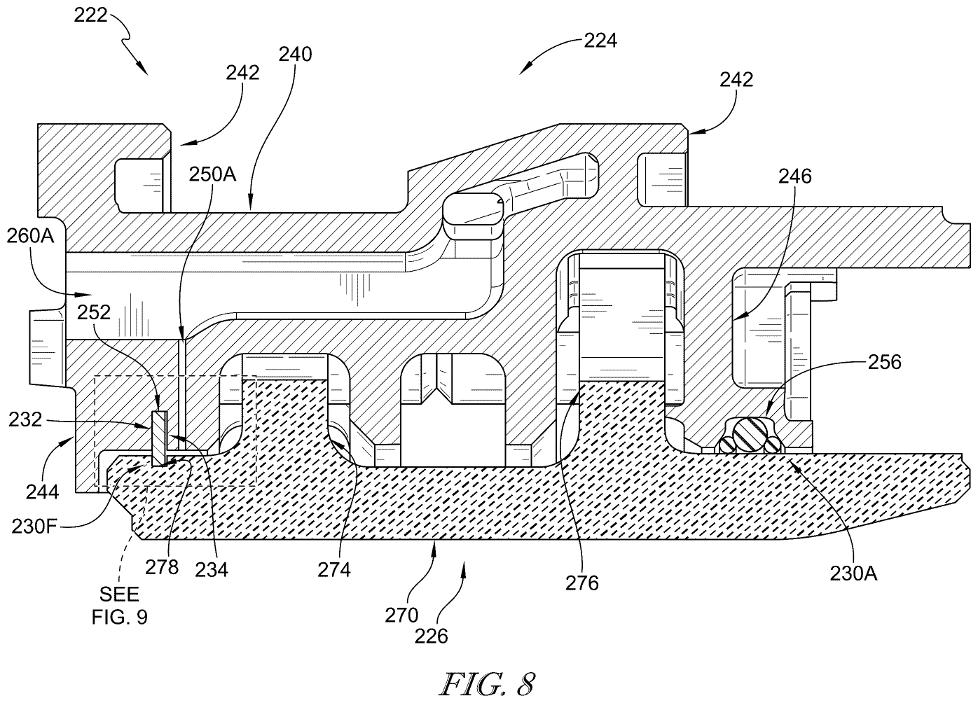

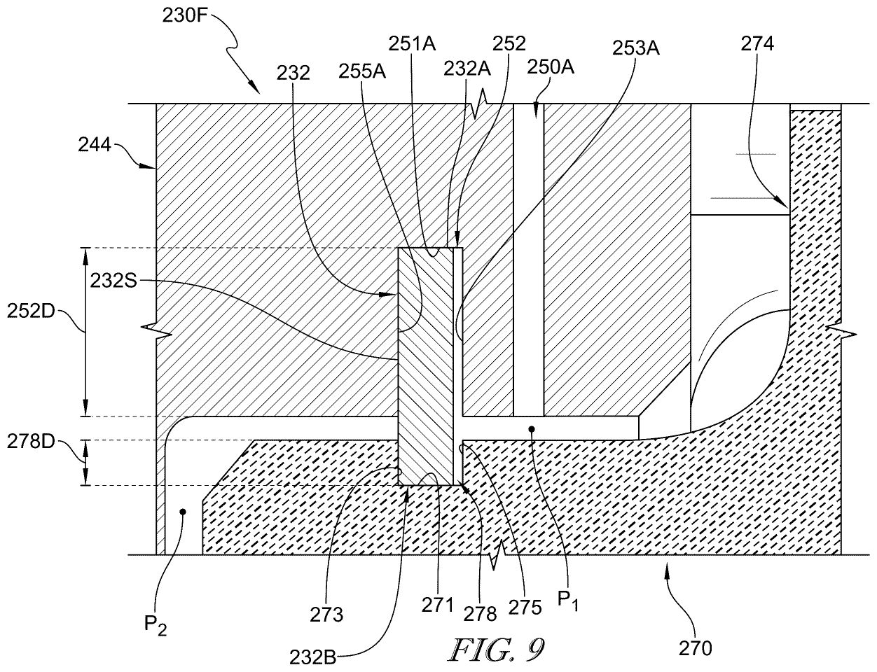

Another embodiment of a turbine shroud segment 222 in accordance with the present disclosure is shown in FIGS. 8 and 9. The turbine shroud segment 222 is substantially similar to the turbine shroud segment 22 shown in FIGS. 1-7 and described herein. Accordingly, similar reference numbers in the 200 series indicate features that are common between the turbine shroud segment 22 and the turbine shroud segment 222. The description of the turbine shroud segment 22 is incorporated by reference to apply to the turbine shroud segment 222, except in instances when it conflicts with the specific description and the drawings of the turbine shroud segment 22.

The turbine shroud segment 222 includes a carrier segment 224 arranged circumferentially at least partway around the axis 11 of the gas turbine engine 10, a blade track segment 226 arranged circumferentially at least partway around the axis 11, and a seal system 230 as shown in FIGS. 8 and 9. The seal system 230 is configured to seal gaps between the carrier segment 224 and the blade track segment 226 to prevent or block gases from a gas path 25 of the gas turbine engine 10 from flowing between the carrier segment 224 and the blade track segment 226.

The seal system 230 includes forward seal assembly 230F located radially between the carrier segment 224 and the blade track segment 226 on a forward side of the blade track segment 226 and an aft seal assembly 230A located radially between the carrier segment 224 and the blade track segment 226 on an aft side of the blade track segment 226. The forward seal assembly 230F-also referred to as the buffer air seal assembly 230F-includes a single seal member 232 instead of two seal members 32, 34 like in the embodiment of FIGS. 1-7.

The seal member 232 extends radially into the carrier segment 224 and the blade track segment 226 as shown in FIGS. 8 and 9. The seal member 32 extends into a radially-inwardly opening first channel 252 formed in the carrier segment 224 and a radially-outwardly opening second channel 278 formed in the blade track segment 226 as shown in FIGS. 8 and 9. Both channels 52, 54 extend circumferentially relative to the axis 11.

The channels 252, 278 define the radially-extending surfaces 255A, 273 that are engaged by the seal member 232 when the region axially aft of the seal member 232 is pressurized with buffer air. The buffer air passageway 250A discharges the buffer air axially aft of the seal member 232 in the illustrative embodiment.

The first channel 252 is defined by a first end surface 251A, a first wall surface 253A, and a second wall surface 255A as shown in FIG. 8. The first wall surface 253A extends radially inward from the first end surface 251A. The second wall surface 255A extends radially inward from the first end surface 251A. The first wall surface 253A is spaced apart axially from the second wall surface 255A to define the first channel 252 therebetween.

The second channel 78 is defined by a second end surface 271, a first shroud-wall surface 273, and a second shroud-wall surface 275 as shown in FIG. 8. The first shroud-wall surface 273 extends radially outward from the third end surface 271. The second shroud-wall surface 275 extends radially outward from the third end surface 271. The second shroud-wall surface 275 is spaced apart axially from the first shroud-wall surface 273.

The seal member 232 includes end surfaces 232A, 232B and a radially-extending surface 232S as shown in FIG. 9. The radially-extending surface 32S of the seal member 232 extends radially between the end surfaces 232A, 232B. The surface 232S of the seal member 32 engages the surface 255A of the carrier segment 224 and the surface 273 of the blade track segment 226.

The seal member 232 is trapped radially between the carrier segment 224 and the blade track segment 226 so that the ends 232A, 232B of the seal member 232 engages the end surfaces 251A, 271 of the channels 252, 278. The buffer air may leak around the ends 232A, 232B of the seal member 232.

Each of the channels 252, 278 also have a rectangular cross-sectional shape when viewed in the circumferential direction relative to the axis 11. The rectangular shape of the channels 252, 278 defines the respective surfaces 251A, 253A, 255A, 271, 273, 275. In the illustrative embodiment, the depth 252D of the first channel 252 is equal to the depth 278D of the second channel 78 as shown in FIG. 9.

The carrier segment 224 includes an outer wall 240, a pair of hangers 242, a forward support wall 244, and an aft support wall 246 as shown in FIGS. 8 and 9. The outer wall 240 extends circumferentially at least partway about the axis 11. The forward support wall 244 extends radially inward from the outer wall 240 axially forward of the first attachment flange 274 of the blade track segment 226 and the aft support wall 246 extends radially inward from the outer wall 40 axially aft of the second attachment flange 276 of the blade track segment 226.

The forward support wall 244 of the carrier segment 224 includes the first channel 252 as shown in FIGS. 8 and 9. The forward support wall 244 is formed to include the first channel 252.

In the illustrative embodiment, the forward support wall 244 includes the buffer air passageway 250A as shown in FIGS. 8 and 9. In the illustrative embodiment, each buffer air passageway 250A extends from an outer cavity 260A formed in the outer wall 240 of the carrier segment 224 as shown in FIGS. 8 and 9. The buffer air flows from the outer cavity 260A to the buffer air passageways 250A.

The blade track segment 226 includes the shroud wall 270 and the attachment flanges 274, 276 as shown in FIGS. 7-9. The shroud wall 270 that extends circumferentially partway around the axis 11. The first attachment flange 274 and the second attachment flange 276 each extend radially outward from the shroud wall 270. The second attachment flange 276 is spaced apart axially from the first attachment flange 274.

A method of assembling and using the turbine shroud segment 222 may include several steps. The method includes arranging the seal member 232 of the seal assembly 230F in the first channel 252 before arranging the blade track segment 226 adjacent to the carrier segment 224. Once the seal member 232 is in the first channel 252, the blade track segment 226 may be arranged adjacent to the carrier segment 224 so that the seal member 232 is radially between the carrier segment 224 and the shroud wall 270 of the blade track segment 226 to block gases in the gas path from flowing between the carrier segment 224 and the blade track segment 226.

The blade track segment 226 is arranged adjacent to the carrier segment 224 so that the seal member 232 also extend into the second channel 278 formed in the shroud wall 270 of the blade track segment 226. The blade track segment 226 is arranged adjacent to the carrier segment 224 so that the first attachment flange 274 and the second attachment flange 276 extend into sections of the cavity 248.

The method further includes discharging a flow of buffer air through the at least one buffer air passageway 250A. The flow of buffer air is suggested by arrows A. The method includes discharging the flow of buffer air through the buffer air passageway 250A radially inward away from the carrier segment axially aft of the seal member 232 to urge the seal member 232 axially forward into engagement with the carrier segment 224 and the blade track segment 26.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine shroud assembly adapted for use with a gas turbine engine, the turbine shroud assembly comprising
a carrier segment arranged circumferentially at least partway around an axis, the carrier segment including an outer wall, a forward support wall that extends radially inward from the outer wall, and an aft support wall that extends radially inward from the outer wall at a location spaced apart axially from the forward support wall to define an attachment-receiving space,
a blade track segment arranged circumferentially at least partway around the axis to define a portion of a gas path of the gas turbine engine, the blade track segment having a shroud wall that extends circumferentially partway around the axis and an attachment feature that extends radially outward from the shroud wall into the attachment-receiving space formed in the carrier segment, and
a buffer air seal assembly located radially between the forward support wall of the carrier segment and the shroud wall of the blade track segment to block gases from flowing between the carrier segment and the blade track segment, the buffer air seal assembly including a first seal member that extends radially into the carrier segment and the blade track segment and a second seal member that extends radially into the carrier segment and the blade track segment, the second seal member spaced apart axially from the first seal member to define a buffer chamber axially therebetween,
wherein the carrier segment is formed to include at least one buffer air passageway configured to discharge buffer air radially inward away from carrier segment into the buffer chamber axially between the first seal member and the second seal member to pressurize the buffer chamber to urge the first seal member axially forward and the second seal member axially aft away from each other and into engagement with radially-extending surfaces defined by the carrier segment and the blade track segment.

2. The turbine shroud assembly of claim 1, wherein the forward support wall is formed to include a radially-inwardly opening first channel and a radially-inwardly opening second channel spaced apart axially from the first channel to define a partition wall therebetween, the first and second channels each extending circumferentially relative to the axis, and the first seal member extends into the first channel and the second seal member extends into the second channel.

3. The turbine shroud assembly of claim 2, wherein the at least one buffer air passageway extends through the partition wall axially between the first channel and the second channel formed in the forward support wall of the carrier segment.

4. The turbine shroud assembly of claim 3, wherein the first channel defines a radially-extending first support-wall surface engaged by the first seal member and the second channel defines a radially-extending second support-wall surface engaged by the second seal member.

5. The turbine shroud assembly of claim 2, wherein the first channel and the second channel each have a rectangular cross-sectional shape viewed circumferentially relative to the axis.

6. The turbine shroud assembly of claim 5, wherein the first channel defines a first end surface, a first support-wall surface that extends radially inward from the first end surface, and a first partition-wall surface that extends radially inward from the first end surface at a location spaced apart axially from the first support-wall surface, wherein the second channel defines a second end surface, a second support-wall surface that extends radially inward from the second end surface, and a second partition-wall surface that extends radially inward from the second end surface at a location spaced apart axially from the second support-wall surface, and wherein the first seal member engages the first support-wall surface and the second seal member engages the second support-wall surface.

7. The turbine shroud assembly of claim 2, wherein the shroud wall is formed to include a radially-outwardly opening third channel that extends circumferentially partway about the axis and axially between the first channel and the second channel, and wherein the first seal member and the second seal member each extend into the third channel.

8. The turbine shroud assembly of claim 7, wherein the third channel that defines a radially-extending first shroud-wall surface engaged by the first seal member and a radially-extending second shroud-wall surface engaged by the second seal member.

9. The turbine shroud assembly of claim 7, wherein the third channel has a rectangular cross-sectional shape viewed circumferentially relative to the axis.

10. The turbine shroud assembly of claim 9, wherein the third channel defines a third end surface, a first shroud-wall surface that extends radially outward from the third end surface, and a second shroud-wall surface that extends radially outward from the third end surface at a location spaced apart axially from the first shroud-wall surface, and wherein the first seal member engages the first shroud-wall surface and the second seal member engages the second shroud-wall surface.

11. The turbine shroud assembly of claim 7, wherein the shroud wall of the blade track segment includes a coating layer on the shroud wall in the third channel and the first seal member and the second seal member engage the coating layer.

12. The turbine shroud assembly of claim 1, wherein the first seal member and the second seal member each have a rectangular cross-sectional shape viewed circumferentially relative to the axis.

13. The turbine shroud assembly of claim 12, wherein the first seal member and the second seal member comprise a solid metallic material.

14. A method comprising:
providing a carrier segment arranged circumferentially at least partway around an axis, the carrier segment formed to include a radially-inwardly opening first channel, a radially-inwardly opening second channel spaced apart axially from the first channel, and at least one buffer air passageway that extends radially into the carrier segment,
providing a blade track segment arranged circumferentially at least partway around the axis, the blade track segment having a shroud wall that extends circumferentially partway around the axis and an attachment feature that extends radially outward from the shroud wall, and the shroud wall formed to include a radially-outwardly opening third channel,
providing a buffer air seal assembly including a first seal member and a second seal member that each extend circumferentially relative to the axis,
arranging the first seal member of the buffer air seal assembly in the first channel formed in the carrier segment,
arranging the second seal member of the buffer air seal assembly in the second channel formed in the carrier segment,
arranging the blade track segment adjacent to the carrier segment so that the first and second seal members extend into the third channel formed in the blade track segment, and
discharging a flow of buffer air through the at least one buffer air passageway radially inward away from the carrier segment axially between the first and second seal members to urge the first seal member axially forward and to urge the second seal member axially aft into engagement with radially-extending surfaces defined by the carrier segment and the blade track segment.

15. The method of claim 14, further comprising applying a coating layer to the shroud wall in the third channel of the shroud wall.

16. The method of claim 14, wherein the first seal member and the second seal member each have a rectangular cross-sectional shape viewed circumferentially relative to the axis.

17. The method of claim 14, wherein the first channel, the second channel, and the third channel each have a rectangular cross-sectional shape viewed circumferentially relative to the axis.

18. The method of claim 14, further comprising providing at least one retainer and inserting the at least one retainer axially into the carrier segment and through the attachment feature of the blade track segment to couple the blade track segment to the carrier segment.
